(19) United States
(12) Patent Application Publication
(10) Pub. No.: US 2009/0277290 A1
(43) Pub. Date: Nov. 12, 2009

(54) WIPER DRIVE

(75) Inventors: Armin Stubner, Buehl-Altschweier (DE); Martin Heyder, Ottersweier (DE); Norbert Martin, Achern (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/305,251

(22) PCT Filed: Oct. 30, 2007
(86) PCT No.: PCT/EP2007/061665

§ 371 Date: Dec. 17, 2008

(30) Foreign Application Priority Data
Dec. 28, 2006 (DE) 10 2006 061 676.6

(51) Int. Cl. B60S 1/06; F16H 21/00

(52) U.S. Cl. 74/25

(57) ABSTRACT

The invention relates to a wiper drive (10), in particular for a window wiping device for a motor vehicle, having a motor and a gear mechanism. Until now, the motor and the gear mechanism have been accommodated in two separate adjoining housings. The gear mechanism housing is manufactured from cast metal. In order to reduce costs, in the wiper drive according to the invention the motor and the gearbox are arranged in a common housing (11).

### BACKGROUND AND SUMMARY OF THE INVENTION

The invention relates to a wiper drive, in particular for a windshield wiping device of a motor vehicle, comprising a motor and a gear mechanism. Until now, an electric motor with a worm gear installed therein has been used for such wiper drives. The electric motor is, in this case, arranged in a pole housing guiding the magnetic flux, whereas the gear mechanism is accommodated in a housing which is made from an aluminum or zinc die casting. The gear mechanism housing is generally closed by a cover made from sheet steel or plastics. The separate housings for the motor and the gear mechanism are costly. This applies, in particular, to the dies for casting the gear mechanism housing.

The object of the invention, therefore, is to improve a wiper drive of the aforementioned type such that the costs are reduced for the housing.

The invention solves the above problem with a wiper drive of the aforementioned type, in which according to the invention a motor and a gear mechanism are arranged in a common housing. The motor and the gear mechanism are thus from now on no longer accommodated in different housings which are to be joined to one another. As a result, the common housing for the motor and the gear mechanism may be produced considerably less expensively than before.

In order to achieve a marked reduction in the production costs of the common housing, the housing may comprise two shells which are symmetrical relative to a common separating plane. The cost for producing the dies of the two shells is thus minimized.

As the electric motor requires a housing, through which a magnetic flux may be passed, the housing may be produced from sheet metal which may be magnetized.

Also for reasons of cost, it is advantageous if the sheet metal is able to be deep-drawn.

Depending on the installation conditions in the vehicle, for example in vehicles with a steering wheel arranged to the left or to the right, the output shaft of the wiper drive may be arranged to the left or to the right, viewed in the direction of the motor axis. Different embodiments of the wiper drive are, therefore, not required. The two shells may be provided with a dome, into which an opening may be incorporated, in order to pass the output shaft through. According to whether the installation space in the vehicle requires a wiper drive with the output shaft arranged to the left or to the right, the opening may be incorporated in either of the two domes. The opening may, for example, be produced by an inactivatable cutting stamp which may be provided in the deep-drawing die.

The wiper drive may, for example, be connected in a cost-effective manner to a wiper rod assembly by a connecting element which may be deep-drawn and/or bent. The connecting element may be advantageously mounted on both shells. Thus one and the same connecting element may be used for wiper drives with the output shaft arranged to the left or to the right. As a result, only one die is required for producing the connecting element.

In order to protect the interior of the housing from moisture and dirt, the two shells may be sealed along a peripheral contact surface by a liquid seal and/or a solid seal.

It is particularly advantageous if the liquid seal is a liquid adhesive, with which the two shells may be connected.

Advantageously, the wiper drive may comprise a bearing shield for fastening a bearing to the housing.

The bearing shield may be a deep-drawn component, also for reasons of cost.

### BRIEF DESCRIPTION OF THE DRAWINGS

An embodiment of the wiper drive according to the invention is explained in more detail hereinafter with reference to the accompanying drawings, in which in detail:

FIG. 1 shows a perspective plan view from above of a wiper drive;

FIG. 2 shows a perspective plan view from below of the wiper drive of FIG. 1;

FIG. 3 shows a perspective internal view of the wiper drive of FIG. 1.

### DETAILED DESCRIPTION

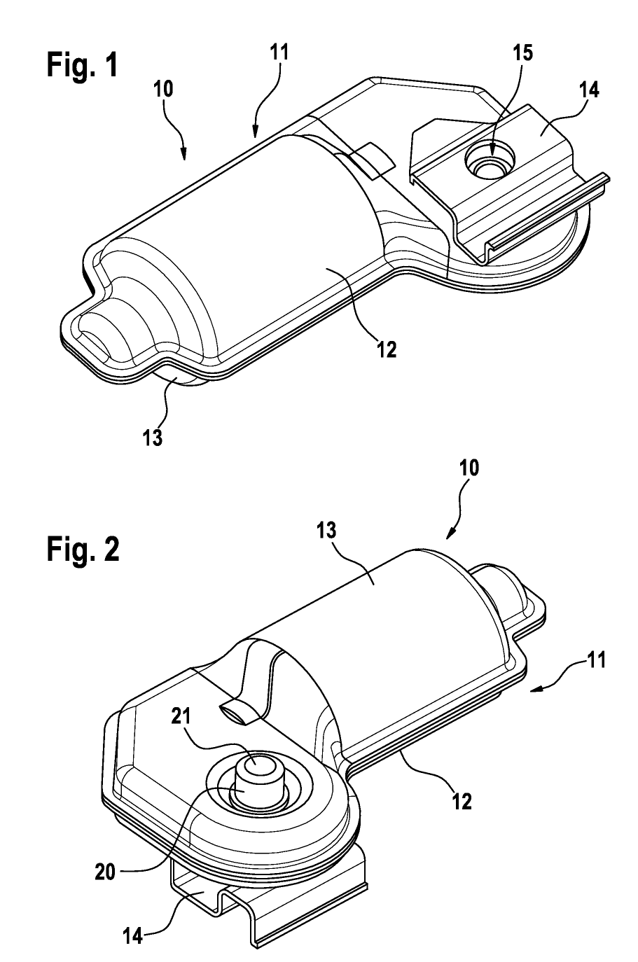

FIGS. 1 and 2 show a wiper drive 10 comprising a housing 11. The housing 11 has two shells 12 and 13.

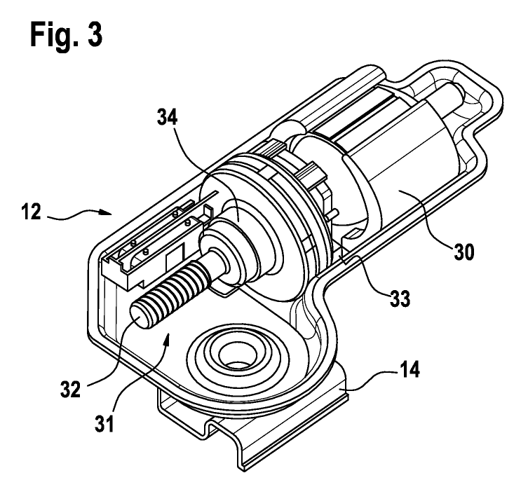

The housing 11 covers a motor 30 and a worm gear 31 together, of which only a worm 32 is shown (see FIG. 3) for reasons of improved clarity.

The two shells 12 and 13 are symmetrical relative to their common separating plane.

The motor 30, which in the present case is an electric motor, makes it necessary for a magnetic flux to be able to be passed through the housing 11. The housing 11 is, therefore, produced from sheet metal which may be magnetized and which is deep-drawn.

The housing 11 is provided with a dome 20 (see FIG. 2), the cap 21 thereof, for example, being able to be cut out by a cutting stamp in the deep-drawing die, in order to pass a drive shaft through, not shown here in more detail.

A connecting element 14 is used for fastening the wiper drive 10 to a wiper rod assembly, not shown here in more detail. The connecting element 14 is also a deep-drawn part and capable of being mounted on either of the two shells 12 and 13.

The connecting element 14 has an opening 15 (see FIG. 1) through which the drive shaft, not shown, may also be passed.

Along a peripheral contact surface 33 (see FIG. 3) a seal may be applied, which after assembling the two shells 12 and 13 protects the interior of the housing 11 from moisture and dirt.

A bearing shield 34 is provided in the housing 11 in order to fasten a bearing, not visible here, to the shell 12. and 13.

The connecting element 14 has an opening 15 (see FIG. 1) through which the drive shaft, not shown, may also be passed.

Along a peripheral contact surface 33 (see FIG. 3) a seal may be applied, which after assembling the two shells 12 and 13 protects the interior of the housing 11 from moisture and dirt.

A bearing shield 34 is provided in the housing 11 in order to fasten a bearing, not visible here, to the shell 12.

1. A wiper drive (10), comprising a motor (30) and a gear mechanism (31), characterized in that the motor (30) and the gear mechanism (31) are arranged in a common housing (11).

2. The wiper drive (10) as claimed in claim 1, characterized in that the housing (11) comprises two shells (12, 13), which are symmetrical relative to a common separating plane.

3. The wiper drive (10) as claimed in claim 1, characterized in that the housing (11) is produced from sheet metal.

4. The wiper drive (10) as claimed in claim 3, characterized in that the sheet metal is deep-drawn.

5. The wiper drive (10) as claimed in claim 2, characterized in that the two shells (12, 13) are provided with a dome (20).

6. The wiper drive (10) as claimed in claim 1, characterized in that the housing (11) may be connected to a wiper rod assembly by a connecting element (14) which may be deep-drawn and/or bent.

7. The wiper drive (10) as claimed in claim 2, characterized in that the two shells (12, 13) may be sealed along a peripheral contact surface (33) by a liquid seal and/or a solid seal.

8. The wiper drive (10) as claimed in claim 7, characterized in that the liquid seal is a liquid adhesive.

9. The wiper drive (10) as claimed in claim 1, characterized in that it comprises a bearing shield (34) for fastening a bearing to the housing.

10. The wiper drive (10) as claimed in claim 9, characterized in that the bearing shield (34) is also a deep-drawn part.

11. The wiper drive (10) as claimed in claim 1, characterized in that the housing (11) is produced from sheet metal which is magnetized.

12. The wiper drive (10) as claimed in claim 11, characterized in that the sheet metal is deep-drawn.

13. The wiper drive (10) as claimed in claim 1, characterized in that the housing (11) is connected to a wiper rod assembly by a connecting element (14).

14. The wiper drive (10) as claimed in claim 2, characterized in that the two shells (12, 13) are sealed along a peripheral contact surface (33).

15. The wiper drive (10) as claimed in claim 14, characterized in that the two shells (12, 13) are sealed along a peripheral contact surface (33) by a liquid adhesive.

16. The wiper drive (10) as claimed in claim 2, characterized in that the housing (11) is produced from sheet metal.

17. The wiper drive (10) as claimed in claim 16, characterized in that the sheet metal is deep-drawn.

18. The wiper drive (10) as claimed in claim 17, characterized in that the two shells (12, 13) are provided with a dome (20).

19. The wiper drive (10) as claimed in claim 18, characterized in that the housing (11) may be connected to a wiper rod assembly by a connecting element (14) which may be deep-drawn and/or bent.

20. The wiper drive (10) as claimed in claim 19, characterized in that the two shells (12, 13) may be sealed along a peripheral contact surface (33) by a liquid seal and/or a solid seal.
